(19) United States
(12) Patent Application Publication
(10) Pub. No.: US 2003/0189611 A1
(43) Pub. Date: Oct. 9, 2003

(54) Jet printer calibration

(76) Inventors: Tai-lin Fan, Boylston, NH (US); Adam I. Pinard, Carlisle, MA (US); Roland Guilmet, Pepperell, MA (US)

Correspondence Address: KRISTOFER E. ELBING, 187 PELHAM ISLAND ROAD, WAYLAND, MA, 01778, US

(21) Appl. No.: 10/118,609

(22) Filed: Apr. 8, 2002

(51) Int. Cl. B41J 29/393

(52) U.S. Cl. 347/19

(57) ABSTRACT

Calibration apparatus is disclosed for a jet printer including a recording medium support having a support surface, and at least one nozzle that is operative to emit an ink jet toward the support surface and is movable along the support surface in a translation direction. The apparatus includes a probe positioned proximate the support surface that includes a plurality of edge portion pairs separated by different distances in a direction along the translation axis, and located at different distances along a test direction perpendicular to the translation direction and proximate the support surface. The apparatus also includes detection circuitry responsive to the probe, and calibration logic responsive to the detection circuitry and having a calibration result output.

### FIELD OF THE INVENTION

This invention relates generally to the calibration of jet printers, such as inkjet printers.

### BACKGROUND OF THE INVENTION

Inkjet printers have come into widespread use because they can print high quality color images at reasonably high speeds. Higher quality versions of such printers usually comprise a rotary drum for supporting a sheet of paper or other recording medium and a print head which is spaced from the drum surface and moved parallel to the drum axis. The movements of the drum and head are coordinated so that the head scans one or more rasters on the drum surface every rotation of the drum. The print head includes one or more ink nozzles (at least one for each color ink), each of which can direct a jet of ink droplets to the paper on the drum. The jets are activated at selected positions in the scan to print an image on the paper composed of an array of ink dots.

Inkjet printing systems can be divided into drop-on-demand and continuous jet systems. In the former, the volume of a pressure chamber filled with ink is suddenly decreased by the impression of an electrical driving pulse whereby an ink droplet is jetted from a nozzle communicating with that chamber. Thus, a single drop of ink is transferred to the paper or other recording medium by a single driving pulse following which the system returns to its original state. During printing, a succession of such droplets is ejected as a jet in response to a succession of drive pulses to print an image on the paper according to a predetermined dot matrix. In the continuous jet-type system, a succession of ink drops is ejected from a jetter or nozzle. Selected ones of these drops are deflected electrostatically into a gutter; the remaining drops reach the paper on the drum and form the printed image thereon according to a predetermined dot matrix. While the present invention is applicable to both jet printer types, the invention will be described primarily as it is applied to a continuous jet-type printer.

Inkjet printers are inherently capable of high speed, high resolution color printing. However, this requires precise manufacture and assembly of the component parts of the printer. Even then, the printer will not print with all colors in proper register unless the printer is calibrated so that the various nozzles on the print head are positioned properly relative to the drum and relative to each other.

In other words, the positions of the printed dots in the direction along the drum (X axis) must be referenced to the home position of the print head. In addition, various nozzles on the print head must be aimed (in yaw) and their actuations timed so that the ink dots produced by all the nozzles at the same dot position in the scan will be in X axis alignment.

The positions of the dots in the direction around the drum are not controlled by aiming the nozzles. Rather, such control is achieved electronically by controlling the timing of the signals that control the jets in relation to the instantaneous position or phase angle of the drum. When the printer is calibrated properly both mechanically and electronically, the different color ink dots produced by the nozzles at a given dot position in the raster scan will be superimposed to form a single well-defined ink dot of a selected, usually subtractive, color.

One prior art approach to printer calibration has employed a moving needle to detect the horizontal and vertical positions of the printer jets. This approach can be applied to multiple jets, but each jet must be calibrated individually. In printers with large numbers of jets, the resulting calibration time can be as long as on the order of 30 minutes.

### SUMMARY OF THE INVENTION

In one general aspect, the invention features calibration apparatus for a jet printer including a recording medium support having a support surface, and at least one nozzle that is operative to emit an ink jet toward the support surface and is movable along the support surface in a translation direction. The apparatus includes a probe positioned proximate the support surface that includes a plurality of edge portion pairs separated by different distances in a direction along the translation axis, and located at different distances along a test direction perpendicular to the translation direction and proximate the support surface. The apparatus also includes detection circuitry responsive to the probe, and calibration logic responsive to the detection circuitry and having a calibration result output.

In preferred embodiments, the probe can include at least one diagonal edge to define the edge portion pairs. The probe can include three filaments configured in a N-shaped configuration. The filaments can each include a first end attached to a first edge of a window in a probe plate and a second end attached to a second edge of a window in the probe plate, with the first and second ends being spaced apart from each other to form an “N”-shaped configuration with extended shoulders. The probe can include a pair of surfaces separated at least in part by a gap, and further include a waste removal path defined by the probe. The apparatus can further include a vacuum source operatively connected to the waste removal path. The waste removal path defined by the probe can be gravity fed and hydraulically separated from the vacuum source. The probe can be made of a pair of plates separated at least in part by a gap, and can further include a waste removal path defined by the probe. The apparatus can further include a separator plate that separates the pair of plates and defines the waste removal path in the gap. The probe can include at least a portion that is substantially aligned with at least a portion of the support surface. The support surface can be a rotatatably mounted cylindrical surface, with the probe being located next to the supporting surface in the direction of an axis of rotation of the supporting surface. The apparatus can further include a head home position detector and wherein the calibration logic is responsive to the head home position detector. The calibration logic can include ink-stream trajectory alignment determination logic operative to detect a relative spatial relationship between drops fired by different jets in a direction perpendicular to the translation axis. The calibration output can be responsive to the trajectory alignment determination logic and is provided to timing circuitry for the nozzle. The calibration logic can include ink-stream relative position determination logic operative to detect a relative spatial relationship between jet nozzles on a print head along the translation axis. The calibration output can be responsive to the relative position determination logic and be provided to timing circuitry for the nozzle. The calibration logic can include swath width determination logic. The calibration output can be a swathing voltage adjustment signal responsive to the swath width determination logic and be provided to a jet deflection circuit for the print nozzle. The calibration logic can include print head path rotation detection logic. The calibration logic can include logic operative to measure a distance between two edge portions. The calibration logic can include logic operative to measure distances between at least two pairs of edge portions disposed in succession in a direction parallel to the axis of rotation. The calibration logic can include boundary detection logic operative to issue a boundary detection signal in response to the detection of signals that correspond to drops deposited outside of a predetermined region that spans a direction perpendicular to the translation direction.

In another general aspect, the invention features calibration apparatus for a jet printer including a recording medium support having a support surface, at least one nozzle which is operative to emit a jet toward the support surface and is movable along the support surface in a translation direction, and a deflection element having a deflection axis for the jet in a direction at least generally parallel to the translation direction. The apparatus includes deflection circuitry operatively connected to the deflection element to set a deflection of the jet during calibration, a probe positioned proximate the support surface, detection circuitry responsive to the probe, and swath-width calibration logic responsive to the detection circuitry and having a calibration result output.

In preferred embodiments, the swath-width calibration logic can include logic operative to detect the jet at two opposite full-scale deflection points. The calibration result output of the swath-width calibration logic can be operative to provide a deflection parameter adjustment output signal. The jet printer can include a plurality of nozzles and interleaving circuitry to interleave drops fired by the nozzles, with the swath-width calibration logic being responsive to signals resulting from drops fired by the plurality of nozzles and operative to adjust the swath width of the plurality of nozzles. The swath-width calibration logic can be responsive to data from a single pass along the translation direction while the deflection circuitry is switched between two deflection points. The deflection circuitry can be switched in short bursts. The deflection circuitry can be switched on an individual drop basis The swath-width calibration logic can be operative to correct differences in results from passes with different deflection circuitry switching rates.

In a further general aspect, the invention features calibration apparatus for an interleaved jet printer including a recording medium support having a support surface, and at least two interleaved print nozzles which are each operative to emit a jet of a same ink toward the support surface and are simultaneously movable along the support surface in a translation direction. The apparatus includes a probe positioned proximate the support surface and in a position within a print range of all of the print nozzles, detection circuitry responsive to the probe, and relative calibration logic responsive to the detection circuitry and having a relative calibration result output for calibration values derived from detection of the same ink from the different print nozzles and expressing print positions for the print nozzles relative to each other. In preferred embodiments, the relative calibration logic can be operative to provide calibration signals for errors both in and perpendicular to the translation direction.

In another general aspect, the invention features calibration apparatus for a jet printer including a recording medium support having a support surface, at least one print nozzle, which is operative to emit a jet toward the support surface and is movable along the support surface in a translation direction. The apparatus includes a plurality of edge portion pairs sufficient to allow for the detection of nozzle position in two dimensions, at least four redundant-edge portions positioned proximate the support surface at a first location along the translation direction, wherein the redundant edge portions are disposed in a direction parallel to the translation direction, detection circuitry responsive to the redundant-edge probe, and calibration logic responsive to the detection circuitry and having a calibration result output. In preferred embodiments, the calibration logic can include correlation logic operative to correlate signals from the detection circuitry with an expected pattern.

In a further general aspect, the invention features calibration apparatus for a jet printer including a recording medium support having a support surface, and at least one nozzle that is operative to emit a jet toward the support surface and is movable along the support surface in a translation direction. The apparatus includes a probe positioned proximate the support surface that includes a pair of surfaces separated at least in part by a gap, and further including a waste removal path defined by the probe, detection circuitry responsive to the probe, and calibration logic responsive to the detection circuitry and having a calibration result output.

In preferred embodiments, the surfaces can be included in plates. The apparatus can further include a separator plate that separates the pair of plates and defines the waste removal path in the gap. The apparatus can further include a vacuum source operatively connected to the waste removal path. The waste removal path defined by the probe can be gravity fed and hydraulically separated from the vacuum source.

In another general aspect, the invention features a calibration method that includes receiving information from different portions of a probe located in a jet trajectory of a moving jet print nozzle, deriving calibration information from the received information, and adjusting the deposition of writing fluid by the print nozzle based on the information derived in the step of deriving.

In preferred embodiments, the step of adjusting can include a step of adjusting deposition timing for the print nozzle. The step of adjusting can include a step of adjusting a deposition position offset for the print nozzle. The step of adjusting can include a step of adjusting a swath width signal for the print nozzle. The step of adjusting includes a first step of adjusting deposition timing for the print nozzle, with the step of adjusting including a second step of adjusting a deposition position offset timing value for the print nozzle, and with the step of adjusting including a third step of adjusting a swath width signal for the print nozzle. At least two of the first, second, and third steps of adjusting can be performed based on data from a same pass.

In a further general aspect, the invention features a calibration method that includes setting a jet deflection to a first setting, causing the jet to interact with a probe, setting the jet deflection to a second setting, again causing the jet to interact with the probe, and deriving swath-width calibration information from results of the steps of causing and again causing.

In another general aspect, the invention features a calibration method that includes causing a jet from a first print nozzle to interact with a probe, causing a jet from a second print nozzle to interact with the probe, detecting signals from the probe resulting form the both of the steps of causing, and deriving a relative calibration result from the step of detecting expressing print positions for the print nozzles relative to each other.

In a further general aspect, the invention features a calibration method that includes causing a jet from a first print nozzle to interact with sufficient probe edges to obtain a position of the first print nozzle in two dimensions, causing the jet to interact with a plurality of further probe edges, deriving a calibration result value form both of the steps of causing.

In another general aspect, the invention features a calibration apparatus that includes means for receiving information from different portions of a probe located in a jet trajectory of a moving jet print nozzle, means for deriving calibration information from the received information, and means for adjusting the deposition of by the print nozzle based on the information derived in the step of deriving.

In a further general aspect, the invention features a calibration apparatus that includes means for setting a jet deflection to different settings, means for causing the jet to interact with the probe at its different settings, and means for deriving swath-width calibration information from the means for causing.

In another general aspect, the invention features a calibration apparatus that includes means for causing jets from successive print nozzles to interact with a probe, means for detecting signals from the probe, and means for deriving a relative calibration result from the means for detecting

In a further general aspect, the invention features a calibration apparatus that includes means for causing a jet from a first print nozzle to interact with sufficient probe means to obtain a position of the first print nozzle in two dimensions, means for causing the jet to interact with a plurality of further probe edges, and means for deriving a calibration result value form both of the means for causing.

Systems according to the invention may be particularly advantageous in that they allow for rapid, accurate, and robust calibration of an inkjet printer using relatively simple calibration hardware. This hardware needs no moving parts and allows a variety of calibration operations to be carried out in just a few scans of the print head. As a result, printers can be equipped with calibration hardware for a relatively low cost and calibration of these systems can be performed frequently without undue delays. It has been found that at least in some cases, calibration can even be performed before each print run.

Systems according to the invention may also be particularly advantageous in the calibration of printers that print multiple rasters in a single revolution using interleaved swathing. Because systems according to the invention can acquire information about swath width and interleave separation from a single, simple calibration element, such systems can provide for rapid and thorough calibration of printers having even a relatively large number of interleave channels.

### BRIEF DESCRIPTION OF THE DRAWING

FIG. 1 is a diagrammatic plan view of a printing system employing calibration according to the invention;

FIG. 2 is a diagrammatic elevation view of the system of FIG. 1, when viewed as shown by the 2-2 lines in FIG. 1;

FIG. 3 is an exploded view of the probe assembly of the system of FIG. 1; and

FIG. 4 is a diagram illustrating an alternative probe geometry for use in the system of FIG. 1.

FIG. 5 is a diagrammatic representation of an output signal from the calibration probe of FIG. 3 for two successive scans shown on aligned time scales;

FIG. 6 is a diagrammatic representation of a portion of the output signal of FIG. 5 shown in the circle labeled “6” on FIG. 5 and shown on magnified time and voltage scales;

FIG. 7 is a diagram illustrating the detection of a print head that is firing too low on a page;

FIG. 8 is a diagram illustrating the detection of an error in the direction of printer carriage travel;

FIG. 9 is a diagram illustrating the detection of a soiled probe; and

FIG. 10 is a diagrammatic representation of an alternative output signal from the calibration probe of FIG. 3 for a combined scan.

### DETAILED DESCRIPTION OF AN ILLUSTRATIVE EMBODIMENT

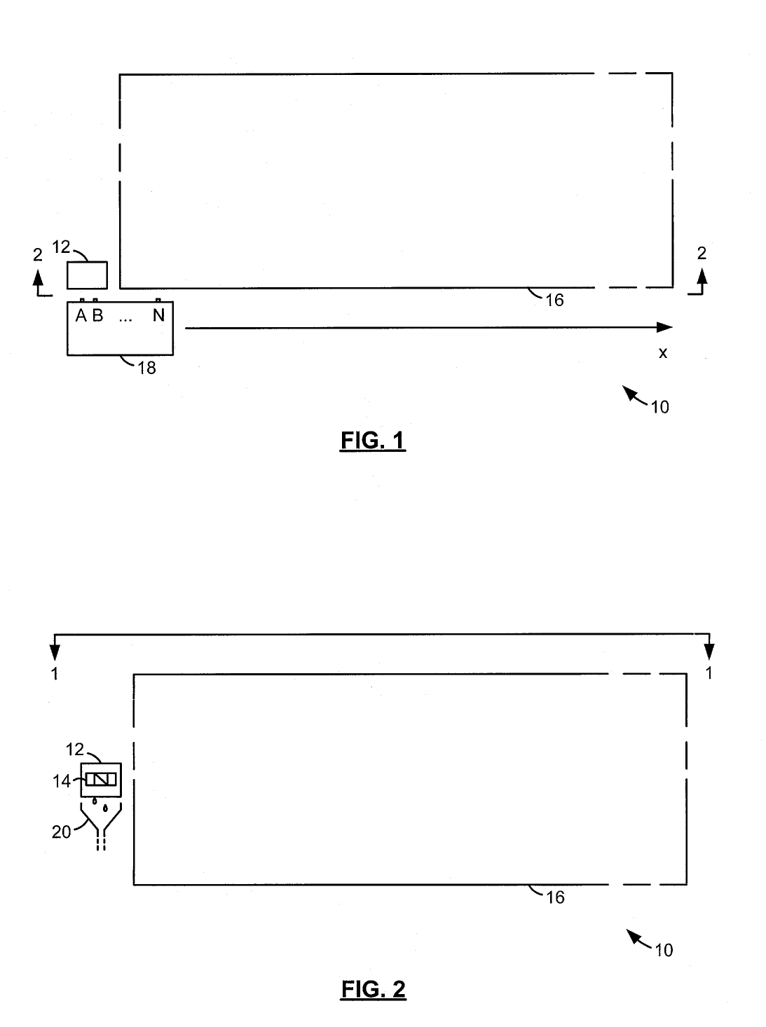

Referring to FIGS. 1 and 2, a printing system 10 according to the invention comprises a calibration probe assembly 12 that includes a probe 14. The assembly is preferably placed next to a print substrate support surface of a printer, such as the outside surface of a platen or drum 16. The probe assembly is preferably located opposite the printer's print head 18 at the same distance from the print head as is the outer surface of a print substrate when supported on the print support surface. The print head can therefore direct drops of ink toward the probe as it travels through a first portion of its path along a longitudinal axis x.

In the present embodiment, the printer is capable of printing multiple rasters in a single revolution using interleaved swathing. Various aspects of the calibration approach described in this application, however, may also be applicable to other types of printers, including so-called direct-to-plate printers in which a liquid is deposited on a plate that is later used in a large-scale printer. A suitable type of printer for use with the present embodiment is described, for example, in copending U.S. patent application Ser. Nos. 09/041,211 and 09/689,370, entitled Printing System, the subject matter of which is published as European Patent Application No. 00308973.7 and herein incorporated by reference.

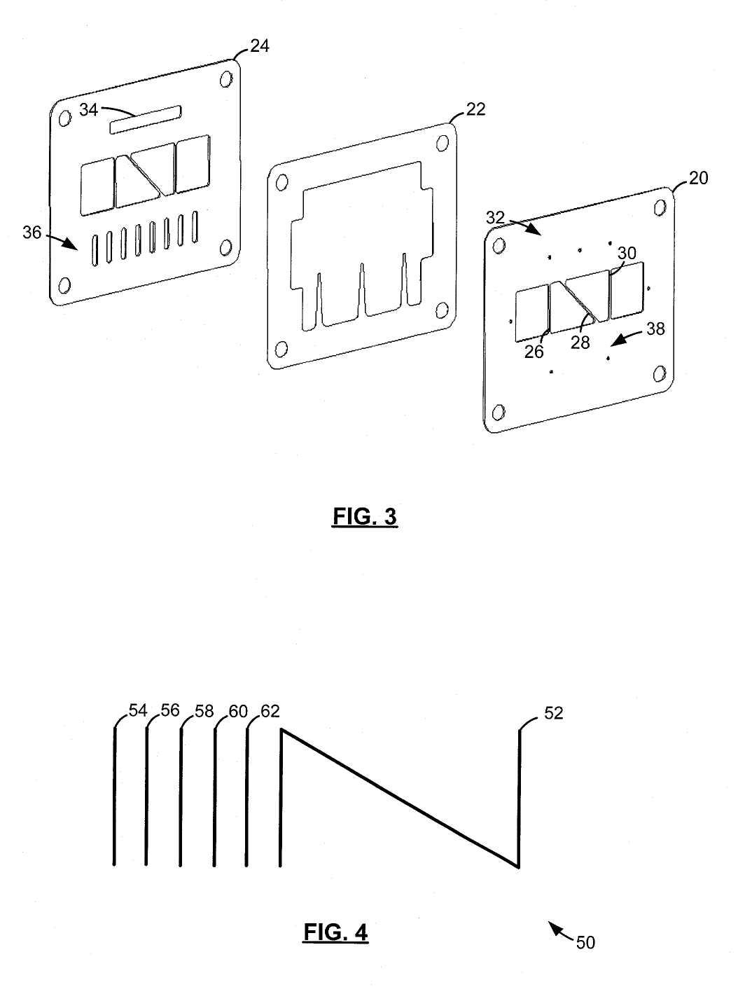

Referring also to FIG. 3, the probe assembly 12 preferably has a housing that supports a sandwich structure, which can include a series of hydrophilic plates. In the present embodiment, these include a front plate 20, a spacer 22, and a back plate 24. Both of the front and back plates contain a rectangular window 32, and these windows each support three filaments that are configured in the shape of capital letter “N”. A slanting filament 28 of the “N”-shape is preferably at a 45° angle with respect to an outer vertical filament 26 and an inner vertical filament 30. The filaments 26, 28, and 30 are also preferably separated from each other in their attachment points to prevent ink buildup that could occur if the filaments were attached at common points. This separation effectively stretches the “N” shape and gives it extended shoulders. The filaments are also tapered at their attachment points to reduce the possibility of breakage.

The “N”-shape is shown with the slanting filament slanted inwardly, but an outwardly slanting orientation is also possible. A variety of other shapes may also be used, as long as they provide the required information. Probes with a number of edge portion pairs separated by different distances in a direction along the carriage translation axis, and located at different distances along a test direction perpendicular to the translation direction, but that are of different shapes, should allow for the detection of the needed two-dimensional geometric information.

Stacking the front plate and the back plate together with the spacer between them creates a cavity between the plates into which ink on the filaments can be drawn by capillary action. The front plate 20 includes holes 38 through which any ink or cleaning fluid that happens to end up on the front of the assembly can be sucked into the capillary cavity. The back plate includes a feed hole 34 that allows for introduction of cleaning fluid into the capillary space from the top and drain holes 36 to allow the fluid to flow out at the bottom. This helps to cleanse residual ink build-up and to prevent foreign particles from clinging to the filaments. It has been observed that this buildup is very slow, so cleaning need only occur as needed.

The cleaning fluid is delivered to the feed hole 36 through a channel in a molded probe housing (e.g., acrylic or Delrin®) to which the plates are fastened with screws, and a catch vessel 20 is preferably located below the probe assembly 12 to catch ink and/or cleaning fluid. A vacuum pump (not shown) can then draw this waste fluid away. The pump and probe and pump are preferably separated by a gap to avoid introducing electrical noise from the motor into the probe assembly through the conductive ink. In this embodiment, the gap is provided between the catch vessel and the probe assembly.

The probe plates can be made of any conductive material, such as etched stainless steel. These can be coated or chemically treated to make them hydrophilic.

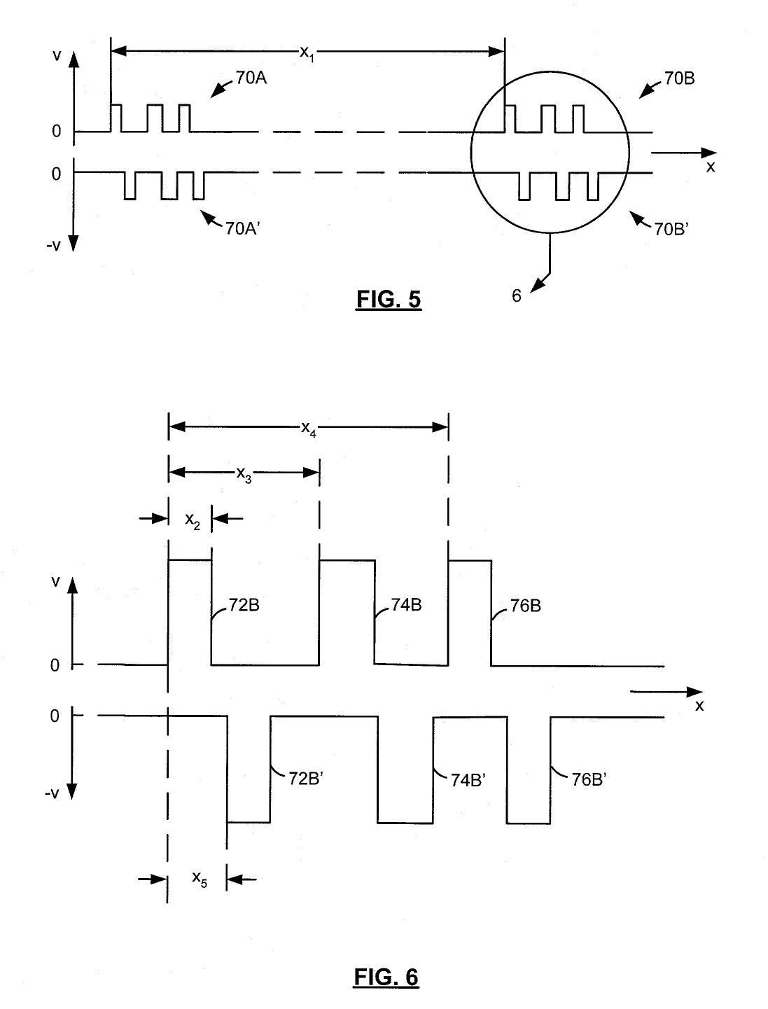

Calibration of the continuous inkjet printer described above will now be described in connection with FIGS. 5-6. This sequence is intended to illustrate the use of a probe assembly according to the invention, but one of skill in the art will recognize that parts of the sequence are applicable to the calibration of other types of printers as well. And while the waveforms shown are representative of the particular probe shape presented in this embodiment, it will be readily apparent to one of ordinary skill that the information conveyed by these waveforms will be available from different waveforms derived from different prove shape variations.

The printer begins a first calibration operation by setting its charge tunnel voltage for the jets under test to a first setting, preferably at the low end of the charge tunnel voltage range, and initiating a pass of the print head along its path in front of the probe assembly. As ink drops from the first jet under test strike the filaments, the probe exhibits a first pulse train 70A. Specifically, when the ink drops begin to strike the outer filament 26, the probe exhibits a first voltage pulse 74A. As they strike the slanted filament 28, the probe exhibits a second voltage pulse 76A. And as they strike the inner filament 30, the probe exhibits a third voltage pulse 78A. Note that while adjusting the deflection of ink drops is accomplished in this embodiment by adjusting a charging tunnel voltage, other embodiments can adjust the deflection of ink drops by adjusting a deflection electrode voltage.

As the print head carriage continues along its path, the ink drops cause the probe to exhibit a second pulse train 70B. If there are more than two jets under test, further pulse trains will also be detected. The nominal value of the separation between pulse trains x₁ will depend on the distance between the jets and the distance between the filaments. It may even be possible to derive calibration information in situations where the pulse trains overlap.

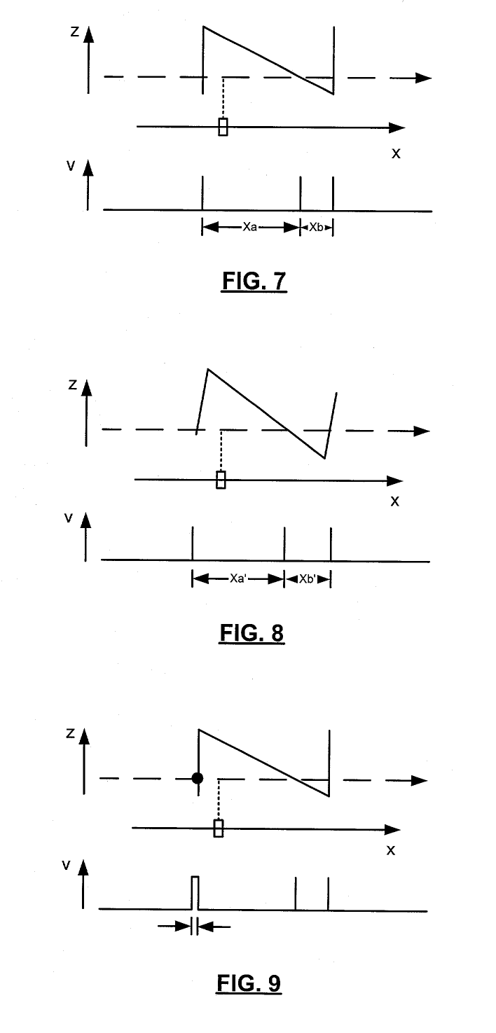

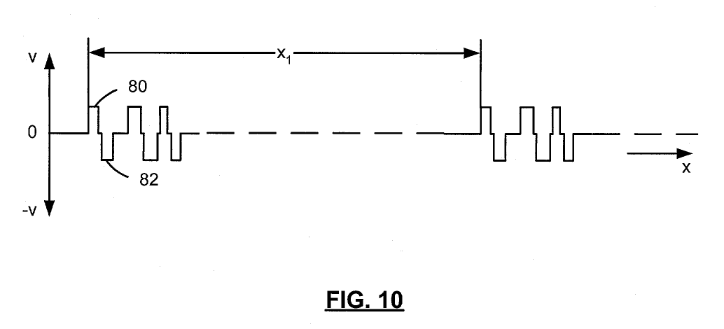

The second half of the calibration operation for a swathed printer is similar to the first half, except that the swathing voltage for the jets under test is set to a second setting, preferably at the high end of the charge tunnel voltage range. And while some computations can take place during the print head scans, all of the calibration measurement values will be available for a complete calibration of the print head once the second half of the calibration operation is complete. The calibration measurements are referenced to a count of micro steps of a stepper motor that drives the print head carriage along its path. The calibration measurements used in this embodiment and their purposes are presented in the following table and FIGS. 7-9.

| Value | Description | Purpose |
|---|---|---|
| x₁ | Nozzle-to- | Measure of distance from one jet nozzle to |
| | nozzle distance | the next. This value can be corrected by |
| | | adjusting a number of stepper motor steps |
| | | counted between the firing of the two nozzles |
| | | to ensure that drops deposited by both nozzles |
| | | are on the same grid. |
| x₂ | Filament width | Measure of width of filament used to detect a |
| | | soiled filament. If this value exceeds a |
| | | predetermined amount, the run is aborted and |
| | | the probe is cleaned. Note that this |
| | | measurement is performed for all of the |
| | | filaments, and the run is aborted if any of |
| | | these measurements are out of range |
| | | (See FIG. 9). |
| x₃ | Outer-to-slanted | Measure of the distance from the outer filament |
| | distance | to the slanted filament. The relationship |
| | | between this distance and the slanted-to-inner |
| | | distance is used to derive the height (z) of the |
| | | nozzle (see xₐ and x_{b} in FIG. 7). Errors in |
| | | height are corrected by adjusting the firing time |
| | | of the nozzles with respect to the drum position |
| | | as reported by a drum position encoder. |
| | | The magnitude of the absolute value of these |
| | | two distances can also be used to detect skew |
| | | in the mounting of the print head (See FIG. 8). |
| | | For a 450 angle, nozzle height can be obtained |
| | | from z = x₄/2 − x₃. |
| x₄ | Slanted-to-inner | This distance is a measure of the distance |
| | distance | from the slanted filament to the inner filament |
| | | and is used in connection with the slanted-to- |
| | | inner distance. |
| x₅ | Swath width | This distance is a measure of the swath width |
| | | and can be changed by adjusting the swathing |
| | | voltage swing between the first and second |
| | | settings. |

Note that not all jets need to be calibrated in a single pass. Calibrations can be performed between sub-groups of interleaved nozzles of the same color and then the groups can be calibrated relative to each other, for example.

It is also preferable to define upper and lower boundary zones for the nozzle. These can be implemented by monitoring nozzle height and detecting whether it exceeds a predetermined upper threshold or falls below a predetermined lower threshold. The system can then shut down and issue an operator alert if there is a transgression of either threshold. This process prevents a potentially more unstable error condition that could occur if the nozzles were to begin depositing ink in the region of the reinforced parts of the filaments.

Referring to FIG. 4, an alternative probe has a geometry 50 that includes one or more additional leading vertical filament elements 54-62, which are of the same or different widths. These filaments serve to produce a leading pulse in the probe signal, which can be recognized using well-known correlative techniques. The use of this type of probe geometry can help to quickly determine probe position with a high degree of accuracy. This approach may be particularly valuable in detecting signals where the calibration pulse trains overlap.

Referring to FIG. 10, an alternative probe sequence can allow swath-width measurements to take place in a single pass. In this sequence, the probe voltage is switched from the first setting to the second setting after a first pulse 80 is detected at the first filament. The first filament can then detect a second pulse 82 for the filament and thereby obtain a value for x₅ in a single pass. The switching can be repeated for all of the filaments in the probe and for all of the nozzles.

It is also possible to continuously switch between the first and second setting for short bursts of drops (e.g., on the order of 50 drops at each setting) or even individual drops. Because of the low bandwidth of the probe sensing amplifier, the resulting waveform will be similar to that shown in FIG. 10. It has been observed, however, that the results of these two approaches differ somewhat. It is therefore important to provide for a correction factor or table to ensure that drop placement is accurately calibrated.

Many features of the fluid management systems according to the invention are also suitable for use in other types of printing systems. These can include other types of ink-based printing systems, such as drop-on-demand inkjet printers. They can also include other types of printing systems, such as direct-to-plate systems, which can dispense a plate-writing fluid. These fluids include direct plate-writing fluids, which by themselves change properties of plates to allow them to be used in printing presses, and indirect plate-writing fluids, which require further process steps.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1. Calibration apparatus for a jet printer including a recording medium support having a support surface, and at least one nozzle that is operative to emit an ink jet toward the support surface and is movable along the support surface in a translation direction, comprising:
a probe positioned proximate the support surface that includes a plurality of edge portion pairs separated by different distances in a direction along the translation axis, and located at different distances along a test direction perpendicular to the translation direction and proximate the support surface,
detection circuitry responsive to the probe, and
calibration logic responsive to the detection circuitry and having a calibration result output.

2. The apparatus of claim 1 wherein the probe includes at least one diagonal edge to define the edge portion pairs.

3. The apparatus of claim 1 wherein the probe includes three filaments configured in a N-shaped configuration.

4. The apparatus of claim 1 wherein the filaments each include a first end attached to a first edge of a window in a probe plate and a second end attached to a second edge of a window in the probe plate, and wherein the first and second ends are spaced apart from each other to form an “N”-shaped configuration with extended shoulders.

5. The apparatus of claim 1 wherein the probe includes a pair of surfaces separated at least in part by a gap, and further including a waste removal path defined by the probe.

6. The apparatus of claim 5 further including a vacuum source operatively connected to the waste removal path.

7. The apparatus of claim 6 wherein the waste removal path defined by the probe is gravity fed and hydraulically separated from the vacuum source.

8. The apparatus of claim 1 wherein the probe is made of a pair of plates separated at least in part by a gap, and further including a waste removal path defined by the probe.

9. The apparatus of claim 8 further including a separator plate that separates the pair of plates and defines the waste removal path in the gap.

10. The apparatus of claim 1 wherein the probe includes at least a portion that is substantially aligned with at least a portion of the support surface.

11. The apparatus of claim 9 wherein the support surface is a rotatatably mounted cylindrical surface and wherein the probe is located next to the supporting surface in the direction of an axis of rotation of the supporting surface.

12. The apparatus of claim 1 further including a head home position detector and wherein the calibration logic is responsive to the head home position detector.

13. The apparatus of claim 1 wherein the calibration logic includes ink-stream trajectory alignment determination logic operative to detect a relative spatial relationship between drops fired by different jets in a direction perpendicular to the translation axis.

14. The apparatus of claim 13 wherein the calibration output is responsive to the trajectory alignment determination logic and is provided to timing circuitry for the nozzle.

15. The apparatus of claim 1 wherein the calibration logic includes ink-stream relative position determination logic operative to detect a relative spatial relationship between jet nozzles on a print head along the translation axis.

16. The apparatus of claim 15 wherein the calibration output is responsive to the relative position determination logic and is provided to timing circuitry for the nozzle.

17. The apparatus of claim 1 wherein the calibration logic includes swath width determination logic.

18. The apparatus of claim 17 wherein the calibration output is a swathing voltage adjustment signal responsive to the swath width determination logic and is provided to a jet deflection circuit for the print nozzle.

19. The apparatus of claim 1 wherein the calibration logic includes print head path rotation detection logic.

20. The apparatus of claim 1 wherein the calibration logic includes logic operative to measure a distance between two edge portions.

21. The apparatus of claim 1 wherein the calibration logic includes logic operative to measure distances between at least two pairs of edge portions disposed in succession in a direction parallel to the axis of rotation.

22. The apparatus of claim 1 wherein the calibration logic includes boundary detection logic operative to issue a boundary detection signal in response to the detection of signals that correspond to drops deposited outside of a predetermined region that spans a direction perpendicular to the translation direction.

23. Calibration apparatus for a jet printer including a recording medium support having a support surface, at least one nozzle which is operative to emit a jet toward the support surface and is movable along the support surface in a translation direction, and a deflection element having a deflection axis for the jet in a direction at least generally parallel to the translation direction, comprising:
deflection circuitry operatively connected to the deflection element to set a deflection of the jet during calibration,
a probe positioned proximate the support surface,
detection circuitry responsive to the probe, and
swath-width calibration logic responsive to the detection circuitry and having a calibration result output.

24. The apparatus of claim 23 wherein the swath-width calibration logic includes logic operative to detect the jet at two opposite full-scale deflection points.

25. The apparatus of claim 23 wherein the calibration result output of the swath-width calibration logic is operative to provide a deflection parameter adjustment output signal.

26. The apparatus of claim 23 wherein the jet printer includes a plurality of nozzles and interleaving circuitry to interleave drops fired by the nozzles and wherein the swath-width calibration logic is responsive to signals resulting from drops fired by the plurality of nozzles and operative to adjust the swath width of the plurality of nozzles.

27. The apparatus of claim 23 wherein the swath-width calibration logic is responsive to data from a single pass along the translation direction while the deflection circuitry is switched between two deflection points.

28. The apparatus of claim 27 wherein the deflection circuitry is switched in short bursts.

29. The apparatus of claim 27 wherein the deflection circuitry is switched on an individual drop basis

30. The apparatus of claim 23 wherein the swath-width calibration logic is operative to correct differences in results from passes with different deflection circuitry switching rates.

31. Calibration apparatus for an interleaved jet printer including a recording medium support having a support surface, and at least two interleaved print nozzles which are each operative to emit a jet of a same ink toward the support surface and are simultaneously movable along the support surface in a translation direction, comprising:
a probe positioned proximate the support surface and in a position within a print range of all of the print nozzles,
detection circuitry responsive to the probe, and
relative calibration logic responsive to the detection circuitry and having a relative calibration result output for calibration values derived from detection of the same ink from the different print nozzles and expressing print positions for the print nozzles relative to each other.

32. The apparatus of claim 31 wherein the relative calibration logic is operative to provide calibration signals for errors both in and perpendicular to the translation direction.

33. Calibration apparatus for a jet printer including a recording medium support having a support surface, at least one print nozzle, which is operative to emit a jet toward the support surface and is movable along the support surface in a translation direction, comprising:
a plurality of edge portion pairs sufficient to allow for the detection of nozzle position in two dimensions,
at least four redundant-edge portions positioned proximate the support surface at a first location along the translation direction, wherein the redundant edge portions are disposed in a direction parallel to the translation direction,
detection circuitry responsive to the redundant-edge probe, and
calibration logic responsive to the detection circuitry and having a calibration result output.

34. The apparatus of claim 33 wherein the calibration logic includes correlation logic operative to correlate signals from the detection circuitry with an expected pattern.

35. Calibration apparatus for a jet printer including a recording medium support having a support surface, and at least one nozzle that is operative to emit a jet toward the support surface and is movable along the support surface in a translation direction, comprising:
a probe positioned proximate the support surface that includes a pair of surfaces separated at least in part by a gap, and further including a waste removal path defined by the probe,
detection circuitry responsive to the probe, and
calibration logic responsive to the detection circuitry and having a calibration result output.

36. The apparatus of claim 35 wherein the surfaces are included in plates.

37. The apparatus of claim 36 further including a separator plate that separates the pair of plates and defines the waste removal path in the gap.

38. The apparatus of claim 35 further including a vacuum source operatively connected to the waste removal path.

39. The apparatus of claim 38 wherein the waste removal path defined by the probe is gravity fed and hydraulically separated from the vacuum source.

40. A calibration method, comprising:
receiving information from different portions of a probe located in a jet trajectory of a moving jet print nozzle,
deriving calibration information from the received information, and
adjusting the deposition of writing fluid by the print nozzle based on the information derived in the step of deriving.

41. The method of claim 40 wherein the step of adjusting includes a step of adjusting deposition timing for the print nozzle.

42. The method of claim 40 wherein the step of adjusting includes a step of adjusting a deposition position offset for the print nozzle.

43. The method of claim 40 wherein the step of adjusting includes a step of adjusting a swath width signal for the print nozzle.

44. The method of claim 40 wherein the step of adjusting includes a first step of adjusting deposition timing for the print nozzle, wherein the step of adjusting includes a second step of adjusting a deposition position offset timing value for the print nozzle, and wherein the step of adjusting includes a third step of adjusting a swath width signal for the print nozzle.

45. The method of claim 44 wherein at least two of the first, second, and third steps of adjusting are performed based on data from a same pass.

46. A calibration method, comprising:
setting a jet deflection to a first setting,
causing the jet to interact with a probe,
setting the jet deflection to a second setting,
again causing the jet to interact with the probe, and
deriving swath-width calibration information from results of the steps of causing and again causing.

47. A calibration method, comprising:
causing a jet from a first print nozzle to interact with a probe,
causing a jet from a second print nozzle to interact with the probe,
detecting signals from the probe resulting form the both of the steps of causing, and
deriving a relative calibration result from the step of detecting expressing print positions for the print nozzles relative to each other.

48. A calibration method, comprising:
causing a jet from a first print nozzle to interact with sufficient probe edges to obtain a position of the first print nozzle in two dimensions,
causing the jet to interact with a plurality of further probe edges,
deriving a calibration result value form both of the steps of causing.

49. A calibration apparatus, comprising:
means for receiving information from different portions of a probe located in a jet trajectory of a moving jet print nozzle,
means for deriving calibration information from the received information, and
means for adjusting the deposition of by the print nozzle based on the information derived in the step of deriving.

50. A calibration apparatus, comprising:
means for setting a jet deflection to different settings,
means for causing the jet to interact with the probe at its different settings, and
means for deriving swath-width calibration information from the means for causing.

51. A calibration apparatus, comprising:
means for causing jets from successive print nozzles to interact with a probe,
means for detecting signals from the probe, and
means for deriving a relative calibration result from the means for detecting

52. A calibration apparatus, comprising:
means for causing a jet from a first print nozzle to interact with sufficient probe means to obtain a position of the first print nozzle in two dimensions,
means for causing the jet to interact with a plurality of further probe edges, and
means for deriving a calibration result value form both of the means for causing.
